(19) United States
(12) Patent Application Publication
(10) Pub. No.: US 2025/0322475 A1
(43) Pub. Date: Oct. 16, 2025

(54) REAL-TIME STUDENT USER BEHAVIOR ANTI-PATTERN DETECTION SYSTEM AND METHOD

(71) Applicant: 2hr Learning, Inc., Austin, TX (US)

(72) Inventor: Ishaan Jain, Delhi (IN)

(73) Assignee: 2hr Learning, Inc., Austin, TX (US)

(21) Appl. No.: 19/177,474

(22) Filed: Apr. 11, 2025

Related U.S. Application Data
(60) Provisional application No. 63/632,997, filed on Apr. 11, 2024.

(51) Int. Cl. G06Q 50/20; H04L 67/50

(52) U.S. Cl. CPC G06Q 50/205; H04L 67/535

(57) ABSTRACT

A real-time anti-pattern detection system integrating a framework into an online learning platform providing communication between the online learning platform and the real-time anti-pattern detection system. The real-time anti-pattern detection system displays the detected anti-patterns via a user interface on the online learning platform in real-time, thereby providing real-time feedback to the user for enhanced engagement and learning. The system is configured to collect session data using a session parser. The session data is parsed to extract one or more events relevant for identification of anti-patterns. The extracted events are shared with an anti-pattern detector. The anti-pattern detector is configured to compare the exact one or more events with a plurality of pre-stored rules The anti-pattern detector compares each event against the pre-stored rules. Upon matching, the anti-pattern detector generates an alert corresponding to the detected anti-patterns, which is displayed to the user via an online learning platform user interface.

### CROSS-REFERENCE TO RELATED APPLICATION

This application claims the benefit under 35 U.S.C. § 119(e) and 37 C.F.R. § 1.78 of U.S. Provisional Application No. 63/632,997, filed Apr. 11, 2024, which is incorporated by reference in its entirety.

### FIELD OF THE INVENTION

The present invention relates in general to the field of electronics, and more specifically to real-time detection of student user behavior anti-patterns in an education environment.

### BACKGROUND OF THE INVENTION

Online learning platforms providing access to various educational topics are popular among students and other learning professionals. The popularity of the online learning platforms is attributed to several factors including—convenience of accessing content from any location using a computing device having stable internet connection, ability to study various courses at one's own pace, and the wide range of subjects and courses available on the platforms. Additionally, the online learning platforms cater to diverse learning styles and preferences, allowing students to choose courses that align with their interests and goals.

Conventionally, engagement of users on the learning platform is measured by taking regular assessments and quizzes. An engagement score is generated after the user completes assigned assessments and quizzes. In some learning platforms, the engagement score is provided based on the time spent by the user on the platform or number of quizzes or assessments taken over a span of time. In some learning platforms, engagement score is generated based on the marks obtained in the attempted exercises or assessments. Typically, the conventional online learning platforms send all the engagement scores along with the activity logs including attempted quizzes and assessments to admins of the learning platform for feedback generation.

The feedback provided to the users by the conventional online learning platform is not immediate and is only available upon completion of the exercises or assessments. The delay in the generation of feedback hinders the ability of the students to promptly address the errors, potentially impeding overall learning progress. Additionally, the online learning platforms systems use single data sources, such as assessment results or time-on-task metrics, to infer student engagement to generate the feedback. However, such methods also do not predict the actual engagement of the user on the learning platform.

### SUMMARY

Embodiments of a method of real-time anti-pattern detection and real-time transforming of user behavior data into an anti-pattern alert includes executing code by one or more processors to cause a computer system to perform operations that include:
receiving collected real-time sensed user behavior data obtained from multiple sensors and transmitted by a data collector integrated in a client-side learning platform, wherein the data collector enhances the client-side learning platform;
in real-time:
   utilizing a real-time anti-pattern detection system to analyze the received real-time sensed user behavior data;
   identifying user anti-pattern behavior based on the analysis of the received real-time sensed user behavior data;
   transforming the analyzed real-time sensed user behavior data into an anti-pattern detection alert signal;
   providing the anti-pattern detection alert signal to a device to alert a user of the device of the anti-pattern detection to correct the anti-pattern behavior.

Embodiments of a system for real-time anti-pattern detection and real-time transforming of user behavior data into an anti-pattern alert include one or more processors. The system also includes a memory, coupled to the one more processors, executing code that causes a computer system to perform operations that include:
receiving collected real-time sensed user behavior data obtained from multiple sensors and transmitted by a data collector integrated in a client-side learning platform, wherein the data collector enhances the client-side learning platform;
in real-time:
   utilizing a real-time anti-pattern detection system to analyze the received real-time sensed user behavior data;
   identifying user anti-pattern behavior based on the analysis of the received real-time sensed user behavior data;
   transforming the analyzed real-time sensed user behavior data into an anti-pattern detection alert signal;
   providing the anti-pattern detection alert signal to a device to alert a user of the device of the anti-pattern detection to correct the anti-pattern behavior.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary real-time anti-pattern detection environment.

FIG. 2 depicts an exemplary anti-pattern detection process for detecting anti-patterns and generating real-time anti-pattern alerts while a user is using an online learning platform.

FIGS. 3-4 depict exemplary user interfaces displaying real-time anti-pattern alerts generated on an online learning platform.

FIG. 5 depicts an exemplary network environment in which the system of FIG. 1 and the process of FIG. 2 may be practiced.

FIG. 6 depicts an exemplary computer system.

### DETAILED DESCRIPTION

A real-time anti-pattern detection system detects anti-patterns in real-time while a user is using an online learning platform. “Antipatterns” refer to patterns of behavior or circumstances that indicate that an individual is not appropriately engaged in a designated task, such as learning online material. The real-time anti-pattern detection system is configured to monitor and analyze user's behavior throughout the session, to identify detrimental learning patterns, also known as anti-pattern. When an anti-pattern is detected, the real-time anti-pattern detection system promptly delivers tailored feedback to the user, with the aim of rectifying the behavior and enriching the learning experience. The anti-pattern detection system solves a technical problem of integrating data streams of various sensor data representing user interactions with the client-side computer system, the user's environment, and any other user behavior in real-time to transform in real-time the data streams into a real-time alert to enable intervention whenever an anti-pattern is detected, thereby fostering a productive learning environment. Antipatterns and detection thereof are discussed in more detail in U.S. Provisional Patent Application No. 63/704,528 and U.S. patent application Ser. No. 19/177,141, which are both hereby incorporated by reference.

The real-time anti-pattern detection system includes integration of a framework onto the online learning platform such that the integration of the framework enables communication between the online learning platform and the real-time anti-pattern detection system. The real-time anti-pattern detection system provides users with real-time generated alerts corresponding to the detected anti-patterns. By presenting generated alerts directly to the user to allow them to interact with the online learning platform. The user interface provides proactive engagement in addressing identified anti-pattern to allow the user to take immediate corrective action, thereby facilitating continuous improvement in their learning behaviors and outcomes. The collection of session data enables precise detection of anti-patterns by providing contextually relevant information for analysis, resulting in more accurate alerts and targeted interventions. The session parser extracts meaningful events from the collected session data. By parsing and organizing the data into structured event to facilitate efficient analysis and interpretation by the anti-pattern detector. The enhances the performance by optimizing the utilization of computational resources and streamlining the detection process to allow the anti-pattern detector for identifying and flagging instances of undesirable learning behaviors. The anti-pattern detector utilizes pre-stored rules to enable rapid and accurate detection in real-time.

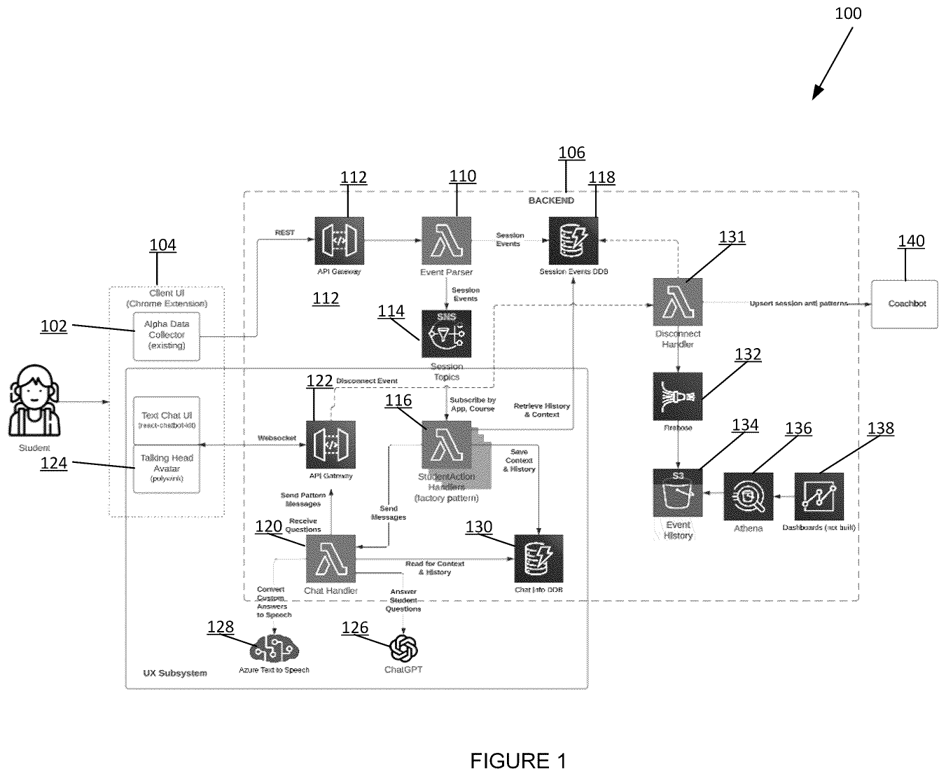

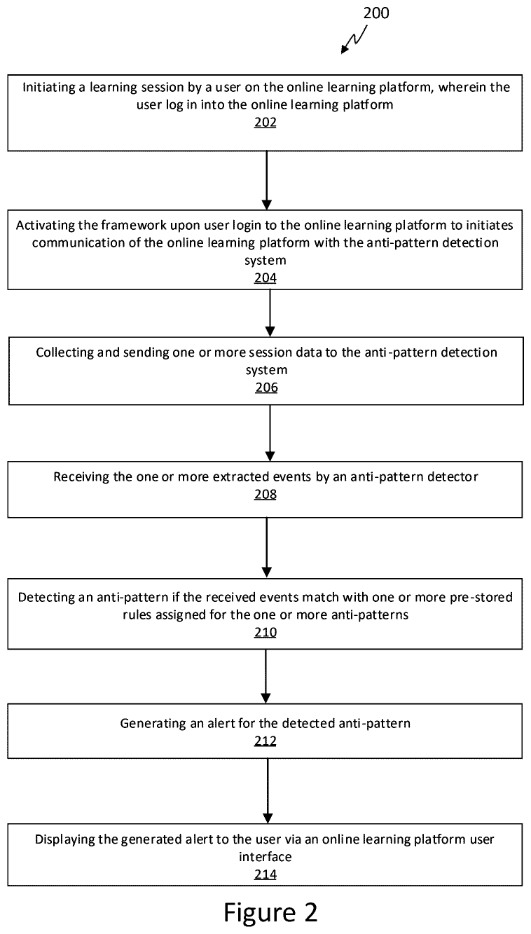

The anti-pattern detector allows to identify and addresses potential challenges in the learning process and help the user to mitigate the risk of ineffective learning strategies among user. The detected anti-patterns are communicated to the user through the alerts. The generated alerts should be clear to the users and each alert includes with distinct codes, detailed explanations, and timestamps to enable the user to understand the nature of the identified issues and take appropriate corrective action. The anti-pattern detector provides a proactive feedback mechanism facilitates timely intervention and enables users to address anti-patterns to provide a supportive learning environment. Typically, the chat handler is utilized that facilitates seamless communication between the real-time anti-pattern detection system and the online learning platform's user interface, ensuring prompt transmission of alerts in real-time. FIG. 1 depicts an exemplary environment 100 for real-time anti-pattern detection while a user is using an enhanced, client-side learning platform 104. FIG. 2 depicts an exemplary anti-pattern detection and anti-pattern alert generation process 200 for anti-pattern detection in an enhanced, client-side learning platform 104.

Referring to FIGS. 1 and 2, in operation 202, a data collector 102 is integrated within an enhanced, client-side learning platform 104 to integrate communication between the enhanced, client-side learning platform 104 and a real-time anti-pattern detection system 106. The data collector 102 is a software program that extends the functionality of the web browser enabling the interaction with the enhanced, client-side learning platform 104. The data collector 102 is designed to integrate with the web browser such as Google Chrome, Microsoft Edge, Mozilla Firefox, Safari or the like. The enhanced, client-side learning platform 104 serves as the digital environment where educational content is hosted and delivered. The choice of learning application executing on the enhanced, client-side learning platform 104 is a matter of design choice, such Aleks, Commonlit, eGumpp, Khan Academy, ReadTheory, Courseware, Duolingo, Seneca or the like. The integration of the data collector 102 within the enhanced, client-side learning platform 104 enhances client-side functionality of enhanced, client-side learning platform 104 by utilizing various sensors to detect user interaction, observe a user via a webcam and/or microphone, external cameras, client-side computer activities, such as key strokes, track or mouse pad movements and selections, and other sensor data with a client-side computer system of the platform 104 collect and forward sensed data to the real-time anti-pattern detection system 106. The number and types of sensors are a matter of design choice. The webcam, microphone, track and mouse pads, keyboard, represent exemplary sensors. In at least one embodiment, the data collector 102 is embedded as a web browser extension, plug-in, or other software program integrated in a web browser, such as a Chrome, Safari, Firefox, or Edge. In at least one embodiment, the enhanced, client-side learning platform 104 executes a learning application locally rather than via a web browser.

The real-time anti-pattern detection system 106 is a system that, in at least one embodiment, synchronizes and analyzes user interaction and behavior sensed data received from the enhanced, client-side learning platform 104 to identify and address anti-patterns of a user 108 while an individual is learning on the enhanced, client-side learning platform 104. Exemplary anti-patterns and coded representations are presented below in Table 1:

TABLE 1

| | | Anti-pattern |
|---|---|---|
| Anti-pattern | Description | Representation |
| Skipping Review | Disregarding key | Code AP1 |
| Center | content | |
| Did not take IXL | Disregarding key | Code AP2 |
| Diagnostics when | content | |
| required | | |
| Distracted chatting to | Not engaging with | Code AP3 |
| colleagues while | content | |
| working on a skill | | |
| Excessive starting over | Unproductive use | Code AP4 |
| | of app | |
| Idling while working on | Not engaging with | Code AP5 |
| a skill | content | |
| Ignoring explanations | Disregarding key | Code AP6 |
| after mistakes | content | |
| Leaving seat while | Not engaging with | Code AP7 |
| working on a skill | content | |
| Listening to music | Unproductive use | Code AP8 |
| while working on a skill | of app | |
| Not finishing lesson | Working on the | Code AP9 |
| before starting new one | wrong content | |
| Not following the | Working on the | Code AP10 |
| recommended order of | wrong content | |
| skills | | |
| Not taking an assigned | Disregarding key | Code AP11 |
| quiz | content | |
| Not watching | Disregarding key | Code AP12 |
| mandatory instructional | content | |
| videos | | |
| Playing with the | Unproductive use | Code AP13 |
| computer | of app | |
| unproductively | | |
| Repeating mastered | Working on the | Code AP14 |
| topics | wrong content | |
| Guiding Questions | Unproductive use | Code AP15 |
| | of app | |
| Rushing questions | Unproductive use | Code AP16 |
| | of app | |
| Rushing through | Unproductive use | Code AP17 |
| reading comprehension | of app | |
| texts | | |
| Selecting skills of a | Working on the | Code AP18 |
| different level/lexile | wrong content | |
| Surfing/Browsing the | Not engaging with | Code AP19 |
| web while working on a | content | |
| skill | | |
| Too many tabs open | Unproductive use | Code AP20 |
| | of app | |
| Using audio support/ | of app | Code AP21 |
| read aloud feature for | Unproductive use | |
| reading comprehension | | |
| skills | | |
| Using audio support | Unproductive use | Code AP22 |
| without reading along | of app | |
| Using external | Using | Code AP23 |
| tools/sources | unauthorized | |
| | content | |
| Webcam covered or | Compromising the | Code AP24 |
| mispositioned | setup | |
| Working on non- | Working on the | Code AP25 |
| recommended skills | wrong content | |
| Loud or distracting | External factors | Code AP26 |
| environment | | |
| Student in distress | External factors | Code AP27 |

In operation 204, the data collector 102 activates when the user 108 successfully logs into the enhanced, client-side learning platform 104. The user 108 logs into the enhanced, client-side learning platform 104 using a user device. Here, the user 108, who is a student, teacher, or any other person, logs into the enhanced, client-side learning platform 104 through a computing device such as a computer, desktop, mobile device or any suitable computing device connected to a stable internet connection. Typically, the user 108 enters his login credentials for authentication and successful login. The credentials can include username and password of the user associated with the enhanced, client-side learning platform 104. After a successful login, the session is started. Here, the term session refers to a duration or time interval for which the user stays logged into the enhanced, client-side learning platform 104. In at least one embodiment, the user 108 is performing at least one of the following activities during the session—solving a problem, completing an assessment, reading through the concept of a lesson or the like. The real-time anti-pattern detection system 106 collects session data to identify one or more anti-patterns while the user is logged into the enhanced, client-side learning platform 104.

The below pseudo code represents the collection and integration of various types of sensed data collected by the enhanced, client-side learning platform 104, including visual (screen and webcam feeds) and digital (browser plugin data) to detect anti-patterns:

```
Extension DataCollector {
  #A function to initialize the extension
  Initialize( ) {
    #Listen for a specific event to start data collection, e.g., a button
click
    ListenForEvent(“startDataCollectionButtonClicked”, CollectData)
  }
  #Function to collect data
  CollectData( ) {
    #Retrieve necessary data from the browser
    browserData = RetrieveBrowserData( )
    #Preprocess the collected data if necessary
    preprocessedData = PreprocessData(browserData)
    #Send the preprocessed data to the backend server via an API
    SendDataToBackend(preprocessedData)
  }
  #Function to retrieve data from the browser
  RetrieveBrowserData( ) {
    #Access the browser's API to collect data
    #This can include tabs, browsing history, cookies, etc.
    #Depending on what the extension is permitted to access
    data = BrowserAPI.AccessData( )
    return data
  }
  #Function to preprocess the data
  PreprocessData(data) {
    #Perform any necessary preprocessing on the collected data
    #This could include formatting, anonymization, or compression
    processedData = Process(data)
    return processedData
  }
  #Function to send data to the backend 100 (FIG. 1) for real-time
processing
  SendDataToBackend(data) {
    #Use an HTTP POST request to send data to the
    server's API endpoint
    APIEndpoint = “https://backend.example.com/data”
    HTTP.POST(APIEndpoint, data)
  }
}
#Instantiate and initialize the extension
dataCollectorExtension = new DataCollector( )
dataCollectorExtension.Initialize( )
```

In operation 206, the session data related to the user 108 during the online sessions is collected and sent to the real-time anti-pattern detection system 106. The session data includes the information corresponding to the user 108 gathered during the interaction of the user 108 with the enhanced, client-side learning platform 104. The session data includes reading the HTTP traffic information, capturing screenshots of the session, video stream of the session, audio feed of the session, capturing browser events, Document Object Model (DOM) and webcam feed. The HTTP traffic information includes requests sent by the user 108 from the web browser to retrieve web resources (such as web pages, images, or documents) and responses received containing the requested information. The screenshots of the enhanced, client-side learning platform 104 during the session include content displayed via the user interface of the enhanced, client-side learning platform 104. In one embodiment, the screenshots can be captured at a time interval of 30 seconds. The real-time anti-pattern detection system 106 can be programmed to automatically capture screenshots at any time interval such as 10, 20, 40, 80 seconds and so on. A continuous video stream of the enhanced, client-side learning platform 104 is also recorded to capture the questions or content displayed on the enhanced, client-side learning platform 104 and the answers provided by the user 108. The audio feed of the user 108 such as sound captured from a microphone or audio input device of the user 108 and continuous monitoring of the web browser interactions, such as clicks, scrolls, and keyboard inputs. The live video stream captured from a webcam of the user 108 is also captured and transmitted to the real-time anti-pattern detection system 106. Document Object Model (DOM) is a structured representation of the web page's content and layout, which can be manipulated and interacted with. The DOM allows dynamically updating the content and behavior of web pages in response to the action of the user 108.

The real-time anti-pattern detection system 106 includes a session parser 110 configured to analyze the received session data, to extract one or more events that are pertinent to the identification of anti-patterns and reject the events that are not needed for detection of one or more anti-patterns. The one or more events are instances or sequences of actions of the user 108 within the online session that may indicate the presence of common pitfalls, inefficiencies, or undesirable behaviors. By extracting the one or more events from the one or more session, the session parser 110 streamlines the subsequent steps in the anti-pattern detection process, focusing on the information that is important for anti-pattern detection. The extracted one or more events serve as an input for accurate and prompt detection of the anti-pattern. The data collector 102 is integrated to the enhanced, client-side learning platform 104 via one or more endpoints 112 including APIs that enables the connection between the enhanced, client-side learning platform 104 and the session parser 110.

The one or more endpoints 112 facilitates data exchange between the enhanced, client-side learning platform 104 and the real-time anti-pattern detection system 106. The one or more endpoints 112 enables the data collector 102 to interact with the enhanced, client-side learning platform 104 to allow the session parser 110 to parse session data from the enhanced, client-side learning platform 104. The session parser 110 enables the real-time anti-pattern detection system 106 to efficiently sift through the session data, helping in generating actionable insights that enables the real-time anti-pattern detection system 106 in detecting anti-patterns.

The real-time anti-pattern detection system 106 further includes a session handler 114. The session handler 114 receives the event data from the session parser 110 and communicates the received data to an anti-pattern detector 116 in real-time for efficient and instantaneous processing of the extracted events, thereby detecting anti-patterns in real-time. In operation 208, the extracted one or more events are then transferred to the anti-pattern detector 116 through the session parser 110. The transfer of the one or more events is analyzed by the anti-pattern detector 116 to detect the anti-patterns. The anti-pattern detector 116 is configured to scrutinize the one or more events, employs algorithms to identify patterns indicative of anti-patterns. The one or more events includes session data including HTTP traffic information, capturing screenshots of the online learning platform, video stream of the online learning platform, audio feed of the user, capturing browser events, Document Object Model (DOM) and webcam feed to synchronize and analyze the data in real-time Multi-Modal Data Analysis is employs which involve data fusion algorithms. Moreover, the anti-pattern detector 116 employs pattern recognition algorithms that can identify patterns indicative of unproductive learning behaviors. For the immediate feedback a stream processing technique is employed that analyzes the one or more events and respond without perceptible delays. The data received including the one or more events may potentially be a large volume of data and the real-time anti-pattern detection system 106 needs to analyze the events data in real-time to generate anti-pattern alerts rapidly without any lag. Typically, the anti-pattern detector 116 uses distributed processing techniques to parallelize the workload across multiple servers or cloud-based infrastructure. Load balancing is employed to distribute the processing load evenly across the real-time anti-pattern detection system 106 to ensure consistent performance as multiple users may use the enhanced, client-side learning platform 104 simultaneously. The load balancing is employed to distribute the processing load evenly across the real-time anti-pattern detection system 106. Moreover, the real-time anti-pattern detection system 106 handles sensitive data of the user 108, the real-time anti-pattern detection system 106 incorporates robust security measures to protect the user 108 privacy, by using encryption and secure data handling protocols.

The anti-pattern detector 116 includes a plurality of pre-stored rules. The plurality of pre-stored rules is predetermined rules established based on analysis and serve as indicative of anti-patterns against which the anti-pattern detector 116 compares the one or more events. The anti-pattern detector 116 scans and evaluates the one or more events to the pre-stored rules to perform analysis for effective detection of anti-patterns. Some of the exemplary pre-stored rules are—user is using external tools, applications or sources; user rushed with low accuracy/guessed answers, user repeated a mastered level, user is idling, restarting, working out of order, skipping learning content, not learning from mistakes, skipping explanations, working on the wrong course, didn't finish a unit before starting a new one or the like.

Notably, each rule from the plurality pre-stored rules defines specific conditions that, when met, trigger the anti-pattern detector 116 indicating the presence of a potential anti-pattern. For example, one of the pre-stored rules from the plurality of pre-stored rules is “rushed with low accuracy/guessed answers” the corresponding condition analyzed by the anti-pattern detector 116 would be “The user did not spend sufficient time (at least 1 minute) per question and gets 2 incorrect concurrently”. Another example of the pre-stored rule is the user 108 is using an external tool. In this scenario, the corresponding condition analyzed by the anti-pattern detector 116 would be “The student used external tools to help solve basic arithmetic/math problems”. The plurality of pre-stored rules enhances the effectiveness and responsiveness in identifying anti-patterns by providing a structured framework for detection. This approach enables the anti-pattern detector 116 to quickly recognize known patterns of undesirable behavior or deviations from established plurality of pre-stored rules, allowing for timely intervention and providing a corrective action. Additionally, the flexibility of having the plurality of pre-stored rules allows for easy modification, expansion, or refinement as new insights or trends emerge, ensuring the real-time anti-pattern detection system 106 remains adaptable and capable of addressing evolving challenges.

In operation 210, the anti-pattern detector 116 efficiently and instantaneously evaluates incoming one or more events against one or more pre-stored rules to identify various types of anti-patterns. The anti-pattern detector 116 stores the extracted events in a database 118. The database 118 is also known as storage, storage medium, digital memory unit, or storage media that stores the extracted events corresponding to the session when the user 108 was logged into the enhanced, client-side learning platform 104. In at least one embodiment, the information stored in the database 118 may be utilized by the user 108 or any person associated with user 108 to check the detected anti-patterns during the online session to allow the tracking of the academic progress of the user 108 over time. Moreover, the stored information highlights the area where the user 108 excels and areas where the user 108 may require extra assistance. When events match with one or more pre-stored rules assigned for the one or more anti-patterns, the anti-pattern is detected.

In operation 212, upon detecting a match between the one or more events and plurality of pre-stored rules, the anti-pattern detector 116 generates an alert to indicate the presence of the identified anti-pattern. In at least one embodiment, the alert contains a distinct code for each of the identified anti-pattern. Thus, the real-time anti-pattern detection system 106 transforms sensed data from enhanced, client-side learning platform 104 into a meaningful representation of one or more detected anti-patterns, such as the codes in Table 1 or any other representation of the one or more detected anti-patterns, such as the description or an abbreviated description.

The distinct code is an individual segment of source code within a software that is characterized by their unique functionality. Each distinct code serves a specific function for each anti-pattern contributing to the cohesive operation of the anti-pattern detector 116. The segments of the distinct code are organized logically to facilitate readability and maintainability. The distinct code facilitates efficient communication and categorizes the detected anti-pattern and understands the nature of the detected anti-pattern. The alert also provides a detailed description of the detected anti-pattern. In at least one embodiment, the description of the generated alert elaborates the characteristics, implications, and meaning of the identified anti-pattern, offering insights into why the anti-pattern has been flagged and guiding appropriate response measures. Moreover, the alert includes a timestamp corresponding to when the anti-pattern is detected. The timestamp records the exact moment when the anti-pattern detector 116 identified the anti-pattern. The generated alerts can be translated based on the language preference of the user 108. The translation ensures that the received alert is understood by the user 108, thereby facilitating clear communication to the user 108. For example, as mentioned above: a pre-stored rule from the plurality of pre-stored rules is “rushed with low accuracy/guessed answers” the corresponding condition analyzed by the anti-pattern detector 116 would be “The user did not spend sufficient time (at least 1 minute) per question and gets 2 incorrect concurrently”. The generated alert would be “Try to calculate your answer, use ‘Explain’ or review the ‘Lessons’ if you are unsure of your answer”.

The below pseudo code is an exemplary data structure to detect an anti-pattern if the received events match with one or more pre-stored rules:

```
#Define a structure for a rule
Class Rule {
  String antipatternMessage
  #Constructor to create a new rule with an associated
  anti-pattern message
  Constructor(message) {
    this.antipatternMessage = message
  }
  #Method to determine if the rule applies to an event
  Method does_apply(incoming_event) {
    #Logic to determine if the rule applies to the event
    #This is a placeholder for actual condition checking
    #Return true if the rule applies, false otherwise
    return true or false
  }
}
#Define the backend system
Backend System {
  Array rules
  #Constructor to create the backend with a set of rules
  Constructor(rulesArray) {
    this.rules = rulesArray
  }
  #Method to evaluate an incoming event against all rules
  EvaluateEvent(incoming_event) {
    String AP_message = “”
    #Iterate over the rules
    For each rule in this.rules {
      #Check if the rule applies to the incoming event
      If (rule.does_apply(incoming_event)) {
        #If the rule applies, assign the committed anti-pattern message
        AP_message = rule.antipatternMessage
        #Break out of the loop if a rule applies
        Break
      }
    }
    #Return the anti-pattern message if any rule applied
    Return AP_message
  }
}
```

Another example, a pre-stored rule from the plurality of pre-stored rules is “Skipping Guiding Questions” the corresponding condition analyzed by the anti-pattern detector 116 would be “The student guesses through guiding questions, resulting in low assessment score”. The generated alert would be “Make sure to answer the guiding questions as you read the text. They will help improve your comprehension and your accuracy in the quiz”. Similarly, if a pre-stored rule from the plurality of pre-stored rules is “Idling” the corresponding condition analyzed by the anti-pattern detector would be “The student was idle in the app for 3 or more minutes without reading passages or solving quizzes”. The generated alert would be “To use your learning session effectively, you should spend your time reading passages and answering questions.”

Additionally, if a pre-stored rule from the plurality of pre-stored rules is “Not working chronologically” the corresponding condition analyzed by the anti-pattern detector 116 would be “The student did not work on their curriculum items in order and instead skipped ahead to a different lesson”. The generated alert would be “You skipped a lesson! To learn effectively, make sure to follow the order of the lessons in the app”. In another example, if a pre-stored rule from the plurality of pre-stored rules is “Advancing without mastery” the corresponding condition analyzed by the anti-pattern detector 116 would be “The student worked on a test they shouldn't have accessed because they haven't met their mastery goals on previous tests”. The generated alert would be “Make sure you achieve 100% on all the unit's Mastery tests before proceeding to the Post Test, and 90% on a Post Test before beginning a new unit”. In yet another example, if a pre-stored rule from the plurality of pre-stored rules is “Abandoning” the corresponding condition analyzed by the anti-pattern detector 116 would be “The student moves to the next topic without achieving a “Proficient” level on their current topic”. The generated alert would be “Make sure you achieve >90% on your topic before advancing to the next exercise”.

The real-time anti-pattern detection system 106 includes a chat handler 120 configured to establish a continuous connection between the real-time anti-pattern detection system 106 and the enhanced, client-side learning platform 104. The chat handler 120 is responsible for managing the flow of messages and serves as a bridge, ensuring that the generated alert is routed to the user 108. Upon the generation of the alert by the anti-pattern detector, 112 the chat handler 120 facilitates the transmission of the generated alert to the enhanced, client-side learning platform 104. To establish the continuous connection between the real-time anti-pattern detection system 106 and the enhanced, client-side learning platform 104 the chat handler 120 utilizes communication protocols to facilitate real-time alert transmission. The chat handler 120 utilizes a chat handler API 122 that provides bidirectional communication therebetween. The chat handler API 122 is an interface that enables communication between the user 108 and enhanced, client-side learning platform 104 in applications or platforms. The chat handler API 122 provides functions for sending and receiving messages, managing user sessions, handling message routing, and integrating with various messaging channels such as text, audio, or video.

The real-time anti-pattern detection system 106 further includes an online learning platform user interface 124 to display the received alert to the user 108. In operation 214, upon identifying the anti-pattern, the received alert is displayed on the online learning platform user interface 124, containing relevant details such as a distinct code, detailed description, and timestamp related to the generated anti-alert. The online learning platform user interface 124 delivers alerts and facilitates effective communication with the user 108. The online learning platform user interface 124 dynamically renders the alert. The online learning platform user interface 124 allows interaction between the user 108 and the real-time anti-pattern detection system 106. The online learning platform user interface 124 includes elements such as buttons, textual or auditory prompts allowing the user 108 to input question, for example, reasons for the generated alert.

The online learning platform user interface 124 is configured to generate a warning if the anti-pattern is detected for a first time thereby prompting the user 108 to improve on the detected anti-pattern. The warning serves as a proactive measure to alert the user 108 about the presence of the anti-pattern to prevent the recurrence of the detected anti-pattern and encourages the user 108 to practice desired behavior while using the enhanced, client-side learning platform 104. When the user 108 consistently adheres to desired behavior, the online learning platform user interface 124 is configured to generate a posi-pattern if no anti-pattern is detected for a pre-determined number of events for the user thereby motivating the user for continuous learning on the online learning platform. The posi-pattern fosters a supportive and encouraging learning environment, for the user 108 to maintain the positive behaviors and strive for continuous improvement. The generation of the posi-pattern represents a proactive intervention to acknowledge and incentivize the commitment of the user 108 for continuous learning and active participation on the enhanced, client-side learning platform 104. The real-time anti-pattern detection system 106 provide a sense of motivation among the user 108 to maintain dedication toward their learning goals. Moreover, by integrating the posi-pattern generation alongside anti-pattern detection, the real-time anti-pattern detection system 106 provides a balanced approach to promoting effective learning behaviors while addressing potential obstacles or challenges that the user 108 may encounter during the session. Error! Reference source not found. represents exemplary posi-patterns:

3Table 2

| | | Posi-pattern |
|---|---|---|
| Posi-pattern | Description | Representation |
| Reading the question | Reading the | Code PP1 |
| carefully before | question carefully | |
| answering correctly | before answering | |
| | and answering it | |
| | correctly. | |
| Watching mandatory | The student | Code PP2 |
| instructional videos | watched the | |
| | mandatory | |
| | instructional | |
| | videos. | |
| Reading the question | The student is | Code PP3 |
| carefully before | trying to focus but | |
| answering correctly | the environment | |
| | around them is | |
| | loud or distracting. | |

In at least one embodiment, the real-time anti-pattern detection system 106 is configured to generate at least three warnings per minute corresponding to the detected anti-pattern before generating the alert for the detected anti-pattern. The warnings are provided to alert the user 108 to the observed behavior and encourage them to modify their approach. In instances where user 108 promptly modify their behavior in response to the warnings, the real-time anti-pattern detection system 106 may not generate the alert for the detected anti-pattern. Instead, the real-time anti-pattern detection system 106 continues to monitor the interactions of the user 108 and provide additional warnings for anti-pattern before generating the alert, to allow user 108 to have a positive change in behavior. The adaptive approach of the real-time anti-pattern detection system 106 ensures that interventions are tailored to the needs of the user 108. However, if the user 108 continues to exhibit the detected anti-pattern, the system proceeds to generate the alert for the detected anti-pattern.

In at least one embodiment, the real-time anti-pattern detection system 106 is configured to generates a first anti-pattern alert when the user 108 completes an activity in less than 3 minutes and scores below 80% thereby prompting the user 108 to work on the lesson to achieve at least 80% accuracy before moving to a next lesson. The real-time anti-pattern detection system 106 is configured to continuously track the user 108 interaction and within the enhanced, client-side learning platform 104 to process the activity of the user 108 in real-time, allowing it to identify instances when the user 108 completes an activity in less than 3 minutes and scores below 80%. In such an instance, the real-time anti-pattern detection system 106 triggers the generation of the first anti-pattern alert prompts “work on the lesson to achieve at least 80% accuracy before moving to a next lesson.” This alert is transmitted to the user 108 on the online learning platform user interface 124. The first anti-pattern alert aims to steer user 108 away from ineffective learning behaviors and towards more productive study habits. By intervening at the moment of engagement with the session, the real-time anti-pattern detection system 106 provides corrective guidance, increasing the likelihood that user 108 to modify the behavior accordingly.

In at least one embodiment, the real-time anti-pattern detection system 106 is configured to a second anti-pattern alert when the user is idle on the online learning platform for a time interval of least 3 minutes, wherein no event is recorded from the received session data for the given time interval. The real-time anti-pattern detection system 106 is configured to continuously track the user 108 interaction and within the enhanced, client-side learning platform 104 to process the user activity in real-time, allowing it to identify instances when the user 108 is idle on the online learning platform for a time interval of least 3 minutes. The real-time anti-pattern detection system 106 detects a prolonged period of user 108 inactivity exceeding the predefined threshold of three minutes, it promptly initiates the generation of the second anti-pattern alert. The second anti-pattern alert is delivered to the user 108 on the online learning platform user interface 124. By intervening promptly following a period of extended idleness, the real-time anti-pattern detection system 106 aims to disrupt the disengagement of the user 108 for enhancing the overall user experience by providing user 108 with timely prompt regarding their idle behavior.

The below is data structure to display the anti-pattern to the user on the online learning platform user interface:

```
message = {
  “message_id”: “string”,
  “critique_message”: “string”,
  “critique_event_code”: “string”,
  “critique_video_uri”: “string”,
  “tutor_responses”: [
    {“response_id”: “string”, “response_text”: “string”},
    {“response_id”: “string”, “response_text”: “string”}
  ],
  “audio_message”: “string”,
  “type”: “MessageType”, #enum values:
  SUGGESTION, ANTIPATTERN,
POSIPATTERN, WARNING
}
```

The chat handler 120 actively utilizes artificial intelligence (AI) tools including large language model (LLM) 126, text to speech convertor 128 to display the generated alert to the user 108 corresponding to the detected anti-pattern on the online learning platform user interface 126. Integration of the AI tools enables the interaction of the user 108 with the enhanced, client-side learning platform 104 in real-time. Moreover, the LLM 126 allows the user 108 to ask questions corresponding to the generated alerts, or may seek for help corresponding to the question displayed on the enhanced, client-side learning platform 104. Furthermore, the text to speech convertor 128 allows the user 108 to raise the query by speaking in the real-time allowing the text to speech convertor 128 to convert the speech into the text and provide the solution thereby. The AI tools provide the user 108 with multiple modalities for receiving information, thereby enhancing accessibility and user experience The LLM 126 allows the real-time anti-pattern detection system 106 to understand and generate text based on detected anti-pattern and continuously trains based data received. The LLM 126 analyze the patterns in language and using them to predict and generate alerts. For example, the LLM 126 can be GPT large language model LLM data collector 102 may utilize the LLM 126 for generative artificial intelligence to generate alerts LLM 126 may include OpenAI having an office in San Francisco, CA. The communication between the user 108 and the chat handler 120 is stored in a chat database 130. The chat database 130 enables the real-time anti-pattern detection system 106 to store all the detected anti-patterns, prompts displayed on the online learning platform user interface 124 during the session. In at least one embodiment, the database 118 and the chat database 130 can be a dynamo database.

In at least one embodiment, the real-time anti-pattern detection system 106 includes automating the process of scheduling calls with the user 108 or with the person associated with the user such as family member, teachers, coach, when the detected anti-pattern is repeated. The real-time anti-pattern detection system 106 is configured to constantly monitor the detected anti-pattern, during the session if the detected anti-pattern is repeated for a set number of times, the real-time anti-pattern detection system 106 schedules a call. Moreover, the scheduling of a call depends on various parameters, such as the frequency, severity, and impact of the observed anti-patterns on the learning progress of the user 108. Once a threshold for the frequency or severity of repeated anti-patterns is surpassed, signifying a potential need for intervention, the real-time anti-pattern detection system 106 initiates the automatic scheduling of a call for the user 108, ensuring timely and targeted support.

Referring to FIG. 1, in at least one embodiment, the real-time anti-pattern detection system 106 further includes a disconnect handler 131 configured to terminate the session of the user 108 on the enhanced, client-side learning platform 104. When triggered, the disconnect handler 131 ends the connection effectively logging out the user 108 from the current session. The real-time anti-pattern detection system 106 performs analytics to ensure robust data processing and interpretation. For analytics a dynamic platform 132, such as Firebase, configured to handle one or more events in real-time. Moreover, the dynamic platform 132 serves as a central hub for collecting, organizing, and managing the session data, one or more extracted events, plurality of pre-stored rules, detected anti-pattern and generated alert pertinent to the analytics process. In at least one embodiment, the session data represents data collected for one session. In at least one embodiment, the session data represents data collected for multiple sessions. Firebase aggregates user behavior metrics, tracking performance indicators, and facilitating data synchronization. Moreover, a Simple Storage Service 134 such as S3 is utilized for the storage of structured and unstructured data, providing a durable repository for datasets, logs, and other relevant information essential for analytics operations. An analytical tool 136 such as Athena is employed to execute ad-hoc SQL queries directly against data stored in the Simple Storage Service 134. The analytical tool 136 streamlines the data enabling swift access to insights without the need for complex data transformation or infrastructure setup. A dashboard 136 is used for displaying the analytics data.

The real-time anti-pattern detection system 106 further includes an artificial intelligence driven coachbot 140 that analyzes session data and antipatterns to, for example, offer guidance, feedback, or training to reduce anti-pattern behaviors.

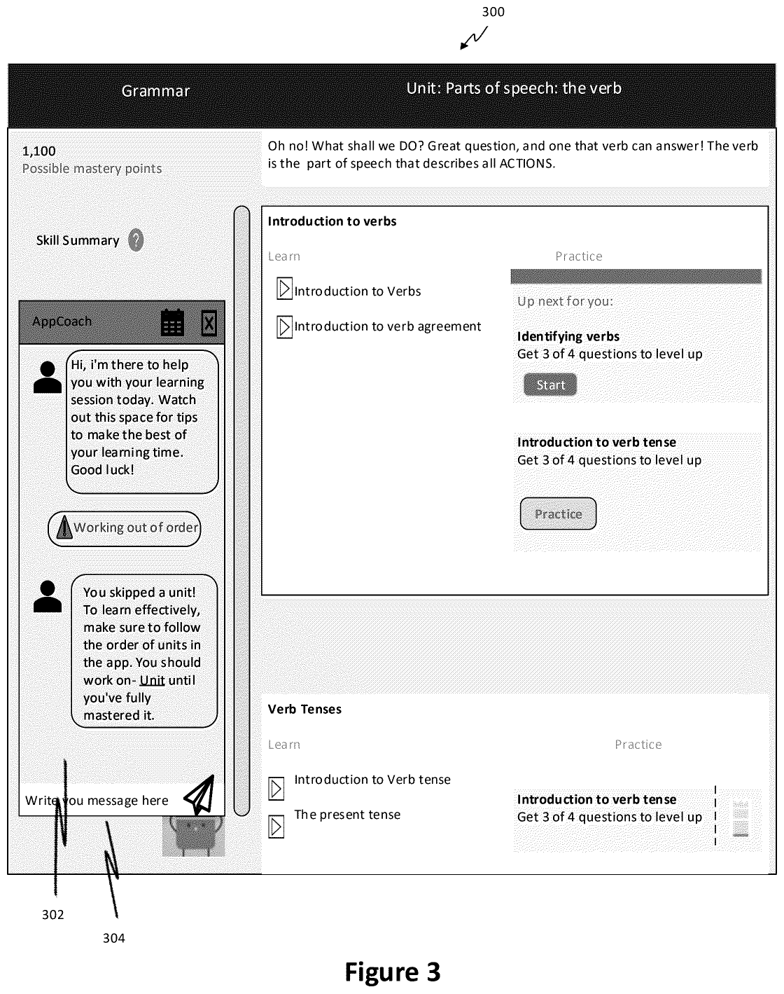

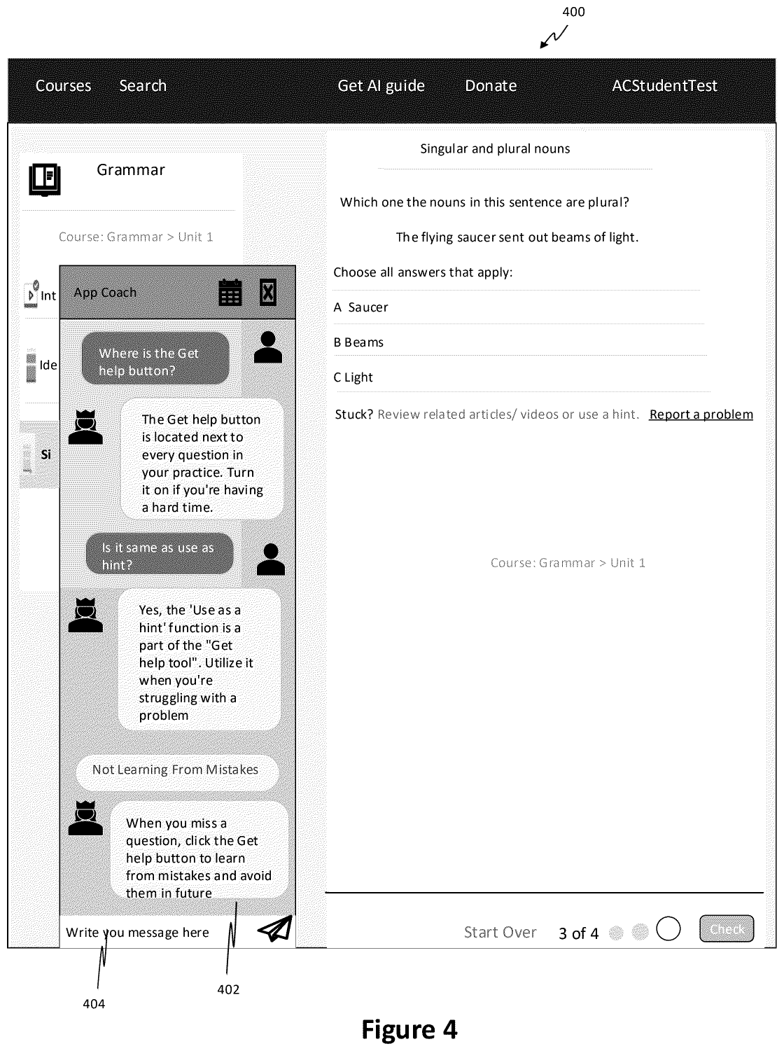

FIGS. 3 and 4 depict exemplary user interfaces displaying real-time anti-pattern alerts generated by the coachbot 140 in online learning platforms 300 and 400. The online learning platform user interface 302 and 402 displays the detected anti-pattern. Referring to FIG. 3, the online learning platform user interface 302 displayed the detected anti-pattern “Working out of order” and also provided the detailed description of the detected anti-pattern “you skipped a Unit! to learn efficiently, make sure to follow the order of the units in the app. You should work on—Unit. Until you've fully mastered it”. Also, the online learning platform user interface 302 allows the user 108 to ask questions in the provided message tab 304. Referring to FIG. 4, the online learning platform user interface 402 displayed the anther detected anti-pattern “Not Learning from Mistakes” and also provided the detailed description of the detected anti-pattern “When you miss a question, click the ‘Get Help’ tool. Utilize when you're struggling with a problem”. Also, the online learning platform user interface 402 allows the user 108 to ask questions in the provided message tab 404.

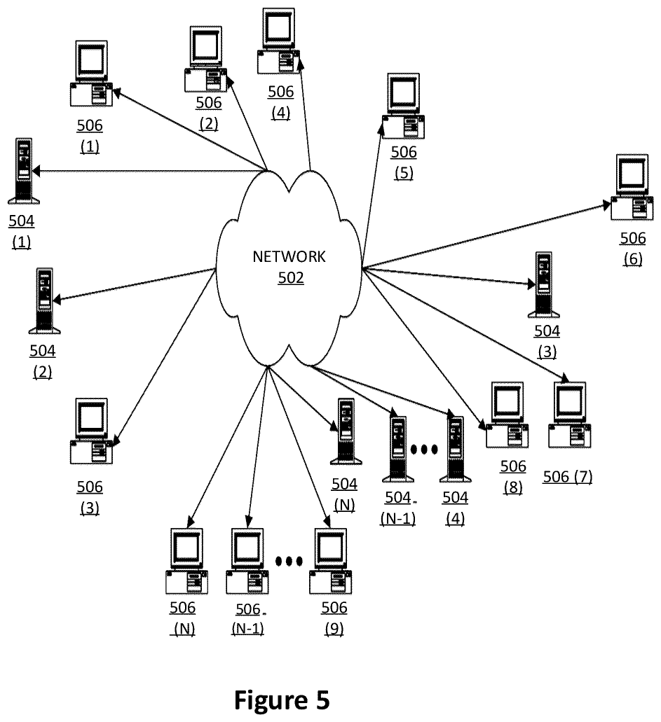

FIG. 5 is a block diagram illustrating a network environment in which the real-time anti-pattern detection system 106 and method 200 may be practiced. Network 502 (e.g. a private wide area network (WAN) or the Internet) includes a number of networked server computer systems 504(1)-(N) that are accessible by client computer systems 506(1)-(N), where N is the number of server computer systems connected to the network. Communication between client computer systems 506(1)-(N) and server computer systems 504(1)-(N) typically occurs over a network, such as a public switched telephone network over asynchronous digital subscriber line (ADSL) telephone lines or high-bandwidth trunks, for example communications channels providing T1 or OC3 service. Client computer systems 506(1)-(N) typically access server computer systems 504(1)-(N) through a service provider, such as an internet service provider (“ISP”) by executing application specific software, commonly referred to as a browser, on one of client computer systems 506(1)-(N).

Client computer systems 506(1)-(N) and/or server computer systems 504(1)-(N) are specialized computer programmed to improve conventional computer systems to implement and utilize the real-time anti-pattern detection system 106 and method 200. The type of computer system that can be specially programmed to implement and utilize the real-time anti-pattern detection system 106 and method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time anti-pattern detection system 106 and method 200 can be implemented using code stored in a tangible, non-transient computer readable medium and executed by one or more processors. In at least one embodiment, the real-time anti-pattern detection system 106 and method 200 can be implemented completely in hardware using, for example, logic circuits and other circuits including field programmable gate arrays.

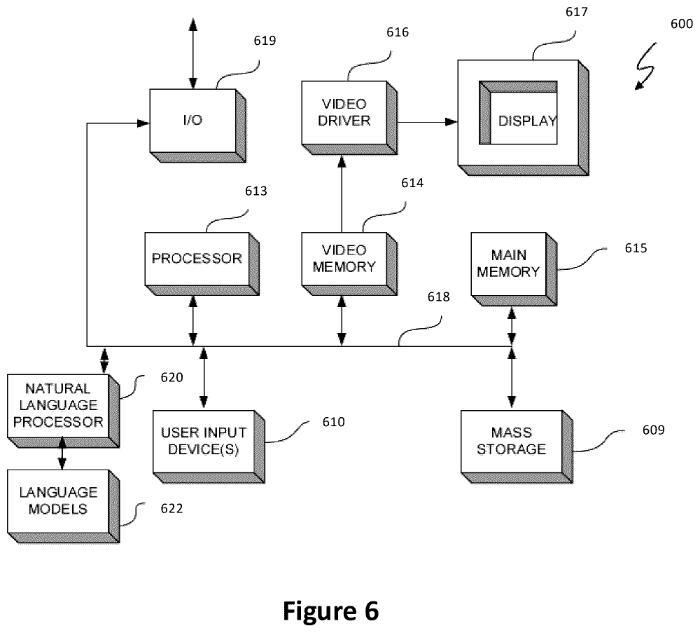

Embodiments of the anti-pattern detection real-time anti-pattern detection system 106 and process 200 for detecting anti-patterns and generating real-time anti-pattern alerts can be implemented on a computer system such as a special-purpose, special-programmed computer 600 illustrated in FIG. 6. Input user device(s) 610, such as a keyboard and/or mouse, are coupled to a bi-directional system bus 618. The input user device(s) 610 are for introducing user input to the computer system and communicating that user input to processor 613. The computer system of FIG. 6 generally also includes a non-transitory video memory 614, non-transitory main memory 615, and non-transitory mass storage 609, all coupled to bi-directional system bus 618 along with input user device(s) 610 and processor 613. The mass storage 609 may include both fixed and removable media, such as a hard drive, one or more CDs or DVDs, solid state memory including flash memory, and other available mass storage technology. Bus 618 may contain, for example, 32 of 64 address lines for addressing video memory 614 or main memory 615. The system bus 618 also includes, for example, an n-bit data bus for transferring DATA between and among the components, such as CPU 609, main memory 615, video memory 614 and mass storage 609, where “n” is, for example, 32 or 64. Alternatively, multiplex data/address lines may be used instead of separate data and address lines.

I/O device(s) 619 may provide connections to peripheral devices, such as a printer, and may also provide a direct connection to a remote server computer systems via a telephone link or to the Internet via an ISP. I/O device(s) 619 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 609, into main memory 615 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 615 is included of dynamic random access memory (DRAM). Video memory 614 is a dual-ported video random access memory. One port of the video memory 614 is coupled to video amplifier 616. The video amplifier 616 is used to drive the display 617. Video amplifier 616 is well known in the art and may be implemented by any suitable means. This circuitry converts pixel DATA stored in video memory 614 to a raster signal suitable for use by display 617. Display 617 is a type of monitor suitable for displaying graphic images.

The computer system described above is for purposes of example only. The anti-pattern detection real-time anti-pattern detection system 106 and process for detecting anti-patterns and generating real-time anti-pattern alerts 200 may be implemented in any type of computer system or programming or processing environment. It is contemplated that the real-time anti-pattern detection system 106 and method 200 might be run on a stand-alone computer system, such as the one described above. The real-time anti-pattern detection system 106 and method 200 might also be run from a server computer systems system that can be accessed by a plurality of client computer systems interconnected over an intranet network. Finally, the real-time anti-pattern detection system 106 and method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of real-time anti-pattern detection and real-time transforming of user behavior data into an anti-pattern alert, the method comprising:
executing code by one or more processors to cause a computer system to perform operations comprising:
receiving collected real-time sensed user behavior data obtained from multiple sensors and transmitted by a data collector integrated in a client-side learning platform, wherein the data collector enhances the client-side learning platform;
in real-time:
utilizing a real-time anti-pattern detection system to analyze the received real-time sensed user behavior data;
identifying user anti-pattern behavior based on the analysis of the received real-time sensed user behavior data;
transforming the analyzed real-time sensed user behavior data into an anti-pattern detection alert signal;
providing the anti-pattern detection alert signal to a device to alert a user of the device of the anti-pattern detection to correct the anti-pattern behavior.

2. The method of claim 1 further comprising:
integrating the data collector into the client-side learning platform to integrate communication between the learning platform and the real-time anti-pattern detection system to:
collect the user behavior data including session data; and
transmit the user behavior data to the real-time anti-pattern detection system, for detection of one or more anti-patterns:
activating the learning platform and the data collector upon user login to the online learning platform, wherein activation of the framework initiates communication of the learning platform and the data collector with the real-time anti-pattern detection system;
collecting and sending session data to the real-time anti-pattern detection system;
parsing the received session data to extract one or more events relevant for identification of one or more anti-patterns;
wherein receiving the collected real-time sensed user behavior data includes receiving the one or more extracted events by an anti-pattern detector;
wherein utilizing the real-time anti-pattern detection system to analyze the received real-time sensed user behavior data and identifying user anti-pattern behavior comprises:
comparing the received events to a plurality of pre-stored rules for detection of any match;
detecting an anti-pattern if the received events match with one or more pre-stored rules assigned for the one or more anti-patterns;
wherein transforming the analyzed real-time sensed user behavior data into an anti-pattern detection alert signal comprises generating the alert signal for the detected anti-pattern, wherein the alert signal includes a distinct code corresponding to the detected anti-pattern, a detailed description of the detected anti-pattern, and a timestamp corresponding to the detection of the anti-pattern; and
providing the anti-pattern detection alert signal to a device to alert a user of the device of the anti-pattern detection to correct the anti-pattern behavior comprises displaying the generated alert to the user corresponding to the detected anti-pattern via an online learning platform user interface.

3. The method of claim 2 wherein collecting and sending session data via the API of the learning platform to the real-time anti-pattern detection system comprises:
reading the HTTP traffic information, capturing screenshots of the learning platform, video stream of the online learning platform, audio feed of the user, capturing browser events, Document Object Model (DOM) and webcam feed.

4. The method of claim 2 wherein collecting session data further comprises capturing screenshots of the learning platform at a time interval of 30 seconds.

5. The method of claim 2 wherein sending session data further comprises:
communicating the extracted events to the real-time anti-pattern detection system in real-time for efficient and instantaneous processing of the events, thereby detecting anti-patterns in real-time; and
storing the extracted events in a database.

6. The method of claim 1 further comprises:
generating a warning if the anti-pattern is detected for a first time thereby prompting the user to improve on the detected anti-pattern.

7. The method of claim 1 further comprises:
generating a posi-pattern if no anti-pattern is detected for a pre-determined number of events thereby motivating the user for continuous learning on the online learning platform.

8. The method of claim 1 further comprising:
generating at least three warnings per minute corresponding to the detected anti-pattern before generating the alert signal for the detected anti-pattern;
generating a first anti-pattern alert signal when the user completes an activity in less than 3 minutes and scores below 80% thereby prompting the user to work on the lesson to achieve at least 80% accuracy before moving to a next lesson; and
generating a second anti-pattern alert signal when the user is idle on the learning platform for a time interval of least 3 minutes, wherein no event is recorded from the received session data for the given time interval.

9. The method of claim 1 further comprises:
displaying the alert signal via a chat window, wherein the chat window allows the user to ask any questions related to the generated alerts and the response to the questions of the user are generated using artificial intelligence (AI) tools.

10. The method of claim 1 wherein the questions asked by the user can be in text, video or audio format, and the response generated corresponding to the asked questions is in a supported format, wherein the response is generated using AI tools including large language model (LLM) and text to speech convertor.

11. A system for real-time anti-pattern detection and real-time transforming of user behavior data into an anti-pattern alert, the system comprising:
one or more processors; and
a memory, coupled to the one more processors, executing code that causes a computer system to perform operations comprising:
receiving collected real-time sensed user behavior data obtained from multiple sensors and transmitted by a data collector integrated in a client-side learning platform, wherein the data collector enhances the client-side learning platform;
in real-time:
utilizing a real-time anti-pattern detection system to analyze the received real-time sensed user behavior data;
identifying user anti-pattern behavior based on the analysis of the received real-time sensed user behavior data;
transforming the analyzed real-time sensed user behavior data into an anti-pattern detection alert signal;
providing the anti-pattern detection alert signal to a device to alert a user of the device of the anti-pattern detection to correct the anti-pattern behavior.

12. The system of claim 11 wherein executing the code causes a computer system to perform operations comprising:
integrating the data collector into the client-side learning platform to integrate communication between the learning platform and the real-time anti-pattern detection system to:
collect the user behavior data including session data; and
transmit the user behavior data to the real-time anti-pattern detection system, for detection of one or more anti-patterns:
activating the learning platform and the data collector upon user login to the online learning platform, wherein activation of the framework initiates communication of the learning platform and the data collector with the real-time anti-pattern detection system;
collecting and sending session data to the real-time anti-pattern detection system;
parsing the received session data to extract one or more events relevant for identification of one or more anti-patterns;
wherein receiving the collected real-time sensed user behavior data includes receiving the one or more extracted events by an anti-pattern detector;
wherein utilizing the real-time anti-pattern detection system to analyze the received real-time sensed user behavior data and identifying user anti-pattern behavior comprises:
comparing the received events to a plurality of pre-stored rules for detection of any match;
detecting an anti-pattern if the received events match with one or more pre-stored rules assigned for the one or more anti-patterns;
wherein transforming the analyzed real-time sensed user behavior data into an anti-pattern detection alert signal comprises generating the alert signal for the detected anti-pattern, wherein the alert signal includes a distinct code corresponding to the detected anti-pattern, a detailed description of the detected anti-pattern, and a timestamp corresponding to the detection of the anti-pattern; and
providing the anti-pattern detection alert signal to a device to alert a user of the device of the anti-pattern detection to correct the anti-pattern behavior comprises displaying the generated alert to the user corresponding to the detected anti-pattern via an online learning platform user interface.

13. The system of claim 12 wherein parsing comprises selectively extraction of one or more events from the received session data and rejects events that are not needed for detection of one or more anti-patterns.

14. The system of claim 12 wherein collecting and sending session data via the API of the learning platform to the real-time anti-pattern detection system comprises:
reading the HTTP traffic information, capturing screenshots of the learning platform, video stream of the online learning platform, audio feed of the user, capturing browser events, Document Object Model (DOM) and webcam feed.

15. The system of claim 12 wherein the alert includes a distinct code corresponding to the detected anti-pattern, a detailed description of the detected anti-pattern, and a timestamp corresponding to the detection of the anti-pattern.

16. The system of claim 12 further comprises a session handler, wherein the session handler receives the event data from the session parser and communicates the received data to the real-time anti-pattern detection system in real-time for efficient and instantaneous processing of the events, thereby detecting anti-patterns in real-time.

17. The system of claim 12 wherein executing the code causes a computer system to perform operations comprising:
the online learning platform user interface to generate a warning if an anti-pattern is detected for a first time thereby prompting a user to improve on the detected anti-pattern.

18. The system of claim 12 wherein generating the alert further comprises:
generating a posi-pattern if no anti-pattern is detected for a pre-determined number of events for the user thereby motivating the user for continuous learning on the online learning platform.

19. The system of claim 12 wherein executing the code causes a computer system to perform operations comprising:
executing a chat handler, wherein the chat handler uses an artificial intelligence (AI) engine and text to speech convertor to display the anti-pattern detection alert signal to the user corresponding to the detected anti-pattern on a learning platform user interface.
